(19) United States
(12) Patent Application Publication
(10) Pub. No.: US 2017/0024835 A1
(43) Pub. Date: Jan. 26, 2017

(54) SYSTEM AND METHOD FOR CREATING CULTURAL HERITAGE TOUR PROGRAM AND HISTORICAL ENVIRONMENT FOR TOURISTS

(71) Applicant: Abbas Aghakhani, Tehran (IR)

(72) Inventor: Abbas Aghakhani, Tehran (IR)

(21) Appl. No.: 15/170,946

(22) Filed: Jun. 2, 2016

Related U.S. Application Data
(63) Continuation-in-part of application No. 14/217,709, filed on Mar. 18, 2014, now abandoned.
(60) Provisional application No. 61/874,016, filed on Sep. 5, 2013.

(51) Int. Cl. G06Q 50/14; G06Q 30/06; G06Q 50/20; G06Q 10/06

(52) U.S. Cl. CPC G06Q 50/14; G06Q 10/06313; G06Q 30/0635; G06Q 50/2057

(57) ABSTRACT

The embodiments herein provide a system and a method for creating a real time environment depending on the historical era preferred by a tourist. The method provides a tour program that provides a historical era experience to the tourists according to their preference. The method allows the tourist to choose the preferred historical era from a list of created historical environment setup. The tourists selecting similar historical era are grouped and allocated with a tourist guide. The tour program provides the tourists with real time event experience of certain situations. The tour program also entertains the tourists by providing situations that create a sense of excitement, fear and other emotions among the tourists.

### RELATED APPLICATIONS

This application is a continuation of U.S. patent application Ser. No. 14/217,709, filed Mar. 18, 2014, which claims the priority of U.S. provisional application Ser. No. 61/874,016, filed May 9, 2013, which are incorporated herein by reference in their entirety for all purposes.

### BACKGROUND

Technical Field

1. The embodiments herein generally relate to tourism industry and tour programs. The embodiments herein particularly relate to a system and a method for providing a cultural and heritage tour program to visit a historical town with an experience of old historical era. The embodiments herein more particularly relate a system and method for creating a historical tour program and a historical environment for the tourists. The embodiments herein more particularly relate to a method for creating a historical environment according to a tourist preference.

Description of the Related Art

2. Ecotourism is becoming more attractive because it is believed that ecotourism makes it possible to improve income generation without harming the environment. Cultural and heritage tourism is a fast growing segment of the tourism industry. This trend is evident in the rise in the volume of tourists who seek adventure, culture, history, archaeology and interaction with local people. For example, cultural and heritage sites are among most preferred tourist locations in America.

3. Most of the historic tourists like to step back in time and get familiar with culture, customs and religion of the time and feel themselves in past time. The past time includes Medieval period, Roman and Greek empire, Iranian empire, crusades, Wild West, etc. Hence there is a need to develop a system and method for creating a cultural and heritage tour program and a real time historical environment that enables a tourist to experience preferred historical eras and events in the present period of time.

4. The above mentioned shortcomings, disadvantages and problems are addressed herein and which will be understood by reading and studying the following specification.

### OBJECT OF THE EMBODIMENTS

5. The primary object of the embodiments herein is to provide a system and a method for creating a cultural heritage tour program for visiting a historical town/city and providing a real time historical environment depending on the historical era preferred by the tourist.

6. Another object of the embodiments herein is to provide a system and a method for creating a tour package that provides an experience of historical era to the tourists.

7. These and other objects and advantages of the embodiments herein will become readily apparent from the following detailed description taken in conjunction with the accompanying drawings.

### SUMMARY

8. The following details present a simplified summary of the embodiments herein to provide a basic understanding of some aspects of the embodiments herein. This summary is not an extensive overview of the embodiments herein. It is not intended to identify key/critical elements of the embodiments herein or to delineate the scope of the embodiments herein. Its sole purpose is to present some concept of the embodiments herein in a simplified form as a prelude to the more detailed description that is presented later.

9. The various embodiments herein provide a method for creating a real time historical environment depending on the historical era preferred by a tourist.

10. According to an embodiment herein, a computer implemented method comprising instructions stored on a non-transitory computer readable storage medium and run on a hardware processor in a computing device for creating a historical tour plan and historical environment of a historical town and era is provided. The method comprises the steps of registering of a user with a portal or a server device of a tourist service provider by logging in a plurality of personal details of the user through a user device. The plurality of personal details of the user comprises name, age, sex, hobbies, address and payment details. A heritage tour program is selected from a plurality of tour programs offered by a tourist service provider system for visiting a desired historical town and era through the user device. The historic era is selected from a group consisting of a medieval period, Roman and Greek empire, Iranian empire, crusades, and wild west. A plurality of participants from the logged in users is grouped for the selected heritage tour program by the server device. The details of the desired historical town and era of the selected heritage tour program are retrieved from a plurality of data sources by the server device. The plurality of data sources comprises a plurality of historians, authors of historical books authentic historic books archaeological documents of historical eras, directors and movie makers of historical era, a plurality of travel websites, social networking sites, and historical Wikipedia. A tour plan is generated for the plurality of participants based on the selected heritage tour program by a tour plan manager device through a tour plan management module. A historical environment is creating and presented using a simulation engine to replicate a lifestyle, culture and environment of the desired historical town and era based on the retrieved details of the desired historical town and era of the selected heritage tour to enable a tour operator to recreate a historical era for visit for the registered users.

11. According to an embodiment herein, the method further comprises collecting details of dressings, clothes, costumes of people who lived in the desired historical town and era by the tour planning module. The dressings, clothes and costumes of people who lived in the desired historical town and era are purchased through e-commerce or online purchase by the tour planning module. The purchased dressings, clothes and costumes of people who lived in the desired historical town and era are stored in a logistics warehouse. The collected dressings, clothes, and costumes are supplied to the plurality of the participants of selected heritage tour program through the tour planning device. An environment of the desired historical town and era is simulated through the simulation engine in a training device for training the plurality of participants to put on the supplied dressings, clothes, costumes through a training module. The plurality of participants is provided with instructions for dressing up the plurality of participants with a make-up of the people who lived in the desired historical town and era through the training module. The plurality of participants is provided with instructions for generating and conducting a plurality of sporting events and entertainments related to the desired historical town and era of the selected heritage tour program through the training module. A plurality of tourist guides is trained on a culture, lifestyle and living of the people of the desired historical town and era by providing instructions through the training module based on the retrieved details of the desired historical town and era of the selected heritage tour program, to train and assist the plurality of participants in wearing the supplied dressings, clothes, costumes and in the dressing up process.

12. According to an embodiment herein, the tour planning manager module is run on a hardware processor and configured to generate and chart the tour plan.

13. According to an embodiment herein, a computing system comprising a hardware processor and a memory is provided for creating a historical tour plan and historical environment of a historical town and era. The system comprises a user device. A server device is configured for receiving a login details of a user from the user device and for supplying a plurality tour programs to the logged in user through the user device. The plurality tour programs comprises a plurality of heritage tour programs. A tour plan manager device is configured to generate a tour plan for the plurality of participants based on the selected heritage tour program through a tour plan management module. The tour plan manager device is further configured to collect details of dressings, clothes, costumes of people who lived in the desired historical town and era with the tour planning module. The tour plan manager device is further configured to purchase dressings, clothes and costumes of people who lived in the desired historical town and era through e-commerce or online purchase. The purchased dressings, clothes and costumes of people who lived in the desired historical town and era are stored in a logistics warehouse. The tour plan manager device is configured to supply the purchased dressings, clothes, costumes to the plurality of the participants of selected heritage tour program. A simulation engine is run on a training system to simulate an environment of the desired historical town and era through a simulation engine for training the plurality of participants to put on the supplied dressings, clothes, costumes. A training module is run on the training system and configured to provide instructions to the plurality of participants for dressing up the plurality of participants with a make-up of the people who lived in the desired historical town and era. The training module is run on the training system and configured for providing instructions to the plurality of participants for generating and conducting a plurality of sporting events and entertainments related to the desired historical town and era of the selected heritage tour program. The training module is run on the training system and configured for providing instructions for training a plurality of tourist guides on a culture, lifestyle and living of the people of the desired historical town and era based on the retrieved details of the desired historical town and era of the selected heritage tour program, to train and assist the plurality of participants in wearing the supplied dressings, clothes, costumes and in the dressing up process. A database is configured for storing a data of the plurality of tour programs, and an itinerary of each tour program. The user device is configured to select a heritage tour program from the plurality of tour programs offered by the tourist service provider for visiting a desired historical town and era. The server device is configured to group a plurality of participants from the logged in users for the selected heritage tour program. The server device is configured to retrieves details of the desired historical town and era of the selected heritage tour program from a plurality of data sources. The historic era is selected from the group consisting of a medieval period, Roman and Greek empire, Iranian empire, crusades, and wild west. The plurality of data sources comprises a plurality of historians, authors of historical books, authentic historic books archaeological document of historical eras, directors and movie makers of historical era, plurality of travel websites, social networking sites, and historical Wikipedia.

14. According to an embodiment herein, the server device is configured to create and present a historical environment to the tour planning manager module to replicate a lifestyle culture and environment of the desired historical town and era based on the retrieved details of the desired historical town and era of the selected heritage tour program.

15. According to an embodiment herein, the server device is configured to receive a plurality of personal details from the user during a login and registering process, and wherein the plurality of personal details of the user comprises name, age, sex, hobbies, address and payment details.

16. According to an embodiment herein, the tour plan manager device is configured to provide instructions for generating and conducting a plurality of sporting events and entertainments related to the desired historical town and era of the selected heritage tour program based on the details of the desired historical town and era of the selected heritage tour program retrieved by the server device.

17. According to an embodiment herein, the tour plan manager device is configured to provide instructions to train a plurality of tourist guides on a culture, lifestyle and living of the people of the desired historical town and era based on the based on the retrieved details of the desired historical town and era of the selected heritage tour program, to train and assist training the plurality of participant to put on the supplied dressings, clothes and costumes.

18. According to an embodiment herein, the server device is configured to provide a demo of a life style, living, dressing, culture, entertainment and sporting activities of the people of the desired historical town and era to the plurality of participants.

19. The various embodiments herein provide a system and method for creating a historical tour plan and historical environment of a historical town and era. According to one embodiment herein, a method is provided for creating a historical tour plan and historical environment of a historical town and era. The method comprises the following steps. A user registers with a portal or a server of a tourist service provider by logging in a plurality of personal details of a user. A heritage tour program is selected from a plurality of tour programs offered by the tourist service provider for visiting a desired historical town and era. A plurality of participants from the logged in users is grouped for the selected heritage tour program. The details of the desired historical town and era of the selected heritage tour program are retrieved from plurality of data sources. A tour plan is generated for the plurality of participants based on the selected heritage tour program. A historical environment is created and presented to replicate a lifestyle, culture and environment of the desired historical town and era based on the retrieved details of the desired historical town and era of the selected heritage tour program.

20. According to one embodiment herein, the method further comprises the following additional steps. The dressings, clothes, costumes of people lived in the desired historical town and era, are collected. The collected dressings, clothes, costumes are supplied to the plurality of the participants of selected heritage tour program. The plurality of participants is trained to put on the supplied dressings, clothes, costumes. The plurality of participants is dressed up with a make-up of the people lived in the desired historical town and era. A plurality of sporting events and entertainments related to the desired historical town and era of the selected heritage tour program is generated and conducted. A plurality of tourist guides is selected and trained on a culture, lifestyle and living of the people of the desired historical town and era based on the based on the retrieved details of the desired historical town and era of the selected heritage tour program, to train and assist the plurality of participants in wearing the supplied dressings, clothes, costumes and in the dressing up process.

21. According to one embodiment herein, the plurality of personal details of a user comprises name, age, sex, hobbies, address and payment details.

22. According to one embodiment herein, the historic era is selected from the group consisting of a medieval period, The Roman and Greek empire, Iranian empire, crusades, and wild west.

23. According to one embodiment herein, the tour plan is generated and charted by a tour planning manager.

24. According to one embodiment herein, the plurality of data sources comprises a plurality of historians, the authors of historical books, the authentic historic books, the archaeological documents of historical eras, the directors and movie makers of historical era, a plurality of travel websites, social networking sites, and historical Wikipedia.

25. According to one embodiment herein, a system is provided for creating a historical tour plan and historical environment of a historical town and era. According to one embodiment herein, the system comprises a user device and a server in a portal of a tourist service provider for receiving a login details of a user from the user device and for supplying a plurality tour programs to the logged in user through the user device. A database is provided for storing a data of the plurality of tour programs, and an itinerary of each tour program. A logistic warehouse is provided for storing a plurality of articles of manufacture and a tour planning manager is connected to the server.

26. According to one embodiment herein, the plurality of tour programs supplied by the server comprise a plurality of heritage tour programs. The user selects a heritage tour program from the plurality of tour programs offered by the tourist service provider for visiting a desired historical town and era. The server groups a plurality of participants from the logged in users for the selected heritage tour program. The server further retrieves the details of the desired historical town and era of the selected heritage tour program from a plurality of data sources. The tour planning manager generates a tour plan for the plurality of participants based on the selected heritage tour program.

27. According to one embodiment herein, the server creates and presents a historical environment to the tour planning manager to replicate a lifestyle, culture and environment of the desired historical town and era based on the retrieved details of the desired historical town and era of the selected heritage tour program.

28. According to one embodiment herein, the server receives a plurality of personal details from the user during a login and registering process. The plurality of personal details of the user comprises name, age, sex, hobbies, address and payment details.

29. According to one embodiment herein, the tour planning manager collects the dressings, clothes, costumes of people lived in the desired historical town and era based on the details of the desired historical town and era of the selected heritage tour program retrieved by the server. The tour planning manager further supplies the collected dressings, clothes, costumes to the plurality of the participants of selected heritage tour program.

30. According to one embodiment herein, the tour planning manager generates and conducts a plurality of sporting events and entertainments related to the desired historical town and era of the selected heritage tour program based on the details of the desired historical town and era of the selected heritage tour program retrieved by the server.

31. According to one embodiment herein, the tour planning manager trains a plurality of tourist guides on a culture, lifestyle and living of the people of the desired historical town and era based on the retrieved details of the desired historical town and era of the selected heritage tour program, to train and assist training the plurality of participants to put on the supplied dressings, clothes, and costumes.

32. According to one embodiment herein, the plurality of tourist guides assists and helps the plurality of participants in dressing up with a make-up of the people lived in the desired historical town and era. The plurality of tourist guides assists and helps the plurality of participants in wearing the supplied dressings, clothes, costumes and in the dressing up process.

33. According to one embodiment herein, the historic era is selected from the group consisting of a medieval period, The Roman and Greek empire, Iranian empire, crusades, and Wild West.

34. According to one embodiment herein, the plurality of data sources comprises a plurality of historians, authors of historical books, authentic historic books, archaeological document of historical eras, directors and movie makers of historical era, plurality of travel websites, social networking sites, and historical Wikipedia.

35. According to one embodiment herein, the plurality of articles of manufacture comprises the dressings, clothes, costumes of people lived in the desired historical town and era collected by the tour planning manager.

36. According to one embodiment herein, the server provides a demo of a life style, living, dressing, culture, entertainment and sporting activities of the people of the desired historical town and era to the plurality of participants.

37. According to one embodiment herein, a computer implemented method is provided for creating a historical tour plan and historical environment of a historical town and era. The method comprises instructions that are stored on a storage medium and are run on a computing device to execute the following steps. A user registers with a portal or a server of a tourist service provider by logging in a plurality of personal details of a user, and the plurality of personal details of the user comprises name, age, sex, hobbies, address and payment details. A heritage tour program is selected from a plurality of tour programs offered by the tourist service provider for visiting a desired historical town and era, and the historical town and era is selected from the group consisting of a medieval period, Roman and Greek empire, Iranian empire, crusades, and wild west. A plurality of participants from the logged in users is grouped for the selected heritage tour program. The details of the desired historical town and era of the selected heritage tour program are retrieved from a plurality of data sources, and the plurality of data sources comprises a plurality of historians, authors of historical books, authentic historic books, archaeological document of historical eras, directors and movie makers of historical era, plurality of travel websites, social networking sites, and historical Wikipedia. A tour plan is generated for the plurality of participants based on the selected heritage tour program. A historical environment is created and presented to replicate a lifestyle, culture and environment of the desired historical town and era based on the retrieved details of the desired historical town and era of the selected heritage tour program.

38. According to one embodiment herein, the dressings, clothes, costumes of people lived in the desired historical town and era are collected.

39. According to one embodiment herein, the collected dressings, clothes, costumes are supplied to the plurality of the participants of selected heritage tour program.

40. According to one embodiment herein, the plurality of participants is trained to put on the supplied dressings, clothes, and costumes.

41. According to one embodiment herein, the plurality of participants is dressed up with a make-up of the people lived in the desired historical town and era.

42. According to one embodiment herein, a plurality of sporting events and entertainments related to the desired historical town and era of the selected heritage tour program are generated and conducted.

43. According to one embodiment herein, a plurality of tourist guides is selected and trained on a culture, lifestyle and living of the people of the desired historical town and era based on the based on the retrieved details of the desired historical town and era of the selected heritage tour program, to train and assist the plurality of participants in wearing the supplied dressings, clothes, costumes and in the dressing up process.

44. These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

45. The other objects, features and advantages will occur to those skilled in the art from the following description of the preferred embodiment and the accompanying drawings in which:

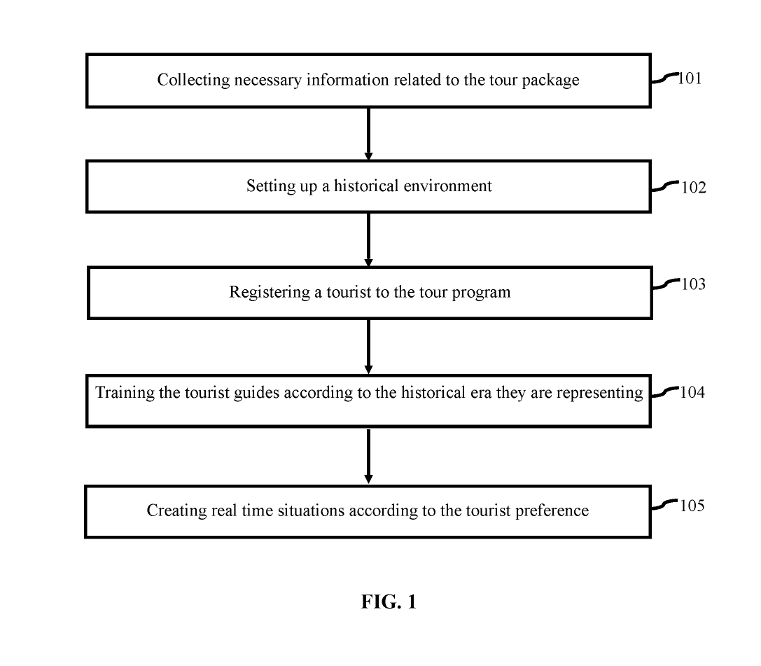

46. FIG. 1 illustrates a flowchart explaining a method for creating a real time environment depending on the historical era preferred by the tourist, according to one embodiment herein.

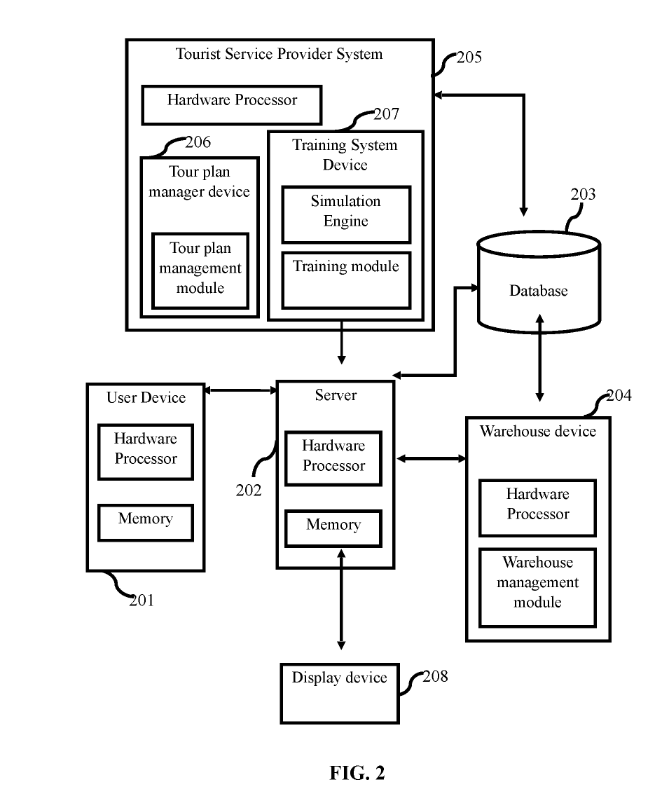

47. FIG. 2 illustrates a block diagram of a system or a portal for creating a cultural and heritage tour program for visiting a historical town/city and creating a historical environment for the tourists, according to one embodiment herein.

48. Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS

49. The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

50. In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

51. The various embodiments herein provide a system and method for creating a historical tour plan and historical environment of a historical town and era.

52. According to an embodiment herein, a computer implemented method comprising instructions stored on a non-transitory computer readable storage medium and run on a hardware processor in a computing device for creating a historical tour plan and historical environment of a historical town and era is provided. The method comprises the steps of registering of a user with a portal or a server device of a tourist service provider by logging in a plurality of personal details of the user through a user device. The plurality of personal details of the user comprises name, age, sex, hobbies, address and payment details. A heritage tour program is selected from a plurality of tour programs offered by a tourist service provider system for visiting a desired historical town and era through the user device. The historic era is selected from a group consisting of a medieval period, Roman and Greek empire, Iranian empire, crusades, and wild west. A plurality of participants from the logged in users is grouped for the selected heritage tour program by the server device. The details of the desired historical town and era of the selected heritage tour program are retrieved from a plurality of data sources by the server device. The plurality of data sources comprises a plurality of historians, authors of historical books authentic historic books archaeological documents of historical eras, directors and movie makers of historical era, a plurality of travel websites, social networking sites, and historical Wikipedia. A tour plan is generated for the plurality of participants based on the selected heritage tour program by a tour plan manager device through a tour plan management module. A historical environment is creating and presented using a simulation engine to replicate a lifestyle, culture and environment of the desired historical town and era based on the retrieved details of the desired historical town and era of the selected heritage tour to enable a tour operator to recreate a historical era for visit for the registered users.

53. According to an embodiment herein, the method further comprises collecting details of dressings, clothes, costumes of people who lived in the desired historical town and era by the tour planning module. The dressings, clothes and costumes of people who lived in the desired historical town and era are purchased through e-commerce or online purchase by the tour planning module. The purchased dressings, clothes and costumes of people who lived in the desired historical town and era are stored in a logistics warehouse. The collected dressings, clothes, and costumes are supplied to the plurality of the participants of selected heritage tour program through the tour planning device. An environment of the desired historical town and era is simulated through the simulation engine in a training device for training the plurality of participants to put on the supplied dressings, clothes, costumes through a training module. The plurality of participants is provided with instructions for dressing up the plurality of participants with a make-up of the people who lived in the desired historical town and era through the training module. The plurality of participants is provided with instructions for generating and conducting a plurality of sporting events and entertainments related to the desired historical town and era of the selected heritage tour program through the training module. A plurality of tourist guides is trained on a culture, lifestyle and living of the people of the desired historical town and era by providing instructions through the training module based on the retrieved details of the desired historical town and era of the selected heritage tour program, to train and assist the plurality of participants in wearing the supplied dressings, clothes, costumes and in the dressing up process.

54. According to an embodiment herein, the tour planning manager module is run on a hardware processor and configured to generate and chart the tour plan.

55. According to an embodiment herein, a computing system comprising a hardware processor and a memory is provided for creating a historical tour plan and historical environment of a historical town and era. The system comprises a user device. A server device is configured for receiving a login details of a user from the user device and for supplying a plurality tour programs to the logged in user through the user device. The plurality tour programs comprises a plurality of heritage tour programs. A tour plan manager device is configured to generate a tour plan for the plurality of participants based on the selected heritage tour program through a tour plan management module. The tour plan manager device is further configured to collect details of dressings, clothes, costumes of people who lived in the desired historical town and era with the tour planning module. The tour plan manager device is further configured to purchase dressings, clothes and costumes of people who lived in the desired historical town and era through e-commerce or online purchase. The purchased dressings, clothes and costumes of people who lived in the desired historical town and era are stored in a logistics warehouse. The tour plan manager device is configured to supply the purchased dressings, clothes, costumes to the plurality of the participants of selected heritage tour program. A simulation engine is run on a training system to simulate an environment of the desired historical town and era through a simulation engine for training the plurality of participants to put on the supplied dressings, clothes, costumes. A training module is run on the training system and configured to provide instructions to the plurality of participants for dressing up the plurality of participants with a make-up of the people who lived in the desired historical town and era. The training module is run on the training system and configured for providing instructions to the plurality of participants for generating and conducting a plurality of sporting events and entertainments related to the desired historical town and era of the selected heritage tour program. The training module is run on the training system and configured for providing instructions for training a plurality of tourist guides on a culture, lifestyle and living of the people of the desired historical town and era based on the retrieved details of the desired historical town and era of the selected heritage tour program, to train and assist the plurality of participants in wearing the supplied dressings, clothes, costumes and in the dressing up process. A database is configured for storing a data of the plurality of tour programs, and an itinerary of each tour program. The user device is configured to select a heritage tour program from the plurality of tour programs offered by the tourist service provider for visiting a desired historical town and era. The server device is configured to group a plurality of participants from the logged in users for the selected heritage tour program. The server device is configured to retrieves details of the desired historical town and era of the selected heritage tour program from a plurality of data sources. The historic era is selected from the group consisting of a medieval period, Roman and Greek empire, Iranian empire, crusades, and wild west. The plurality of data sources comprises a plurality of historians, authors of historical books, authentic historic books archaeological document of historical eras, directors and movie makers of historical era, plurality of travel websites, social networking sites, and historical Wikipedia.

56. According to an embodiment herein, the server device is configured to create and present a historical environment to the tour planning manager module to replicate a lifestyle culture and environment of the desired historical town and era based on the retrieved details of the desired historical town and era of the selected heritage tour program.

57. According to an embodiment herein, the server device is configured to receive a plurality of personal details from the user during a login and registering process, and wherein the plurality of personal details of the user comprises name, age, sex, hobbies, address and payment details.

58. According to an embodiment herein, the tour plan manager device is configured to provide instructions for generating and conducting a plurality of sporting events and entertainments related to the desired historical town and era of the selected heritage tour program based on the details of the desired historical town and era of the selected heritage tour program retrieved by the server device.

59. According to an embodiment herein, the tour plan manager device is configured to provide instructions to train a plurality of tourist guides on a culture, lifestyle and living of the people of the desired historical town and era based on the based on the retrieved details of the desired historical town and era of the selected heritage tour program, to train and assist training the plurality of participant to put on the supplied dressings, clothes and costumes.

60. According to an embodiment herein, the server device is configured to provide a demo of a life style, living, dressing, culture, entertainment and sporting activities of the people of the desired historical town and era to the plurality of participants.

61. According to one embodiment herein, a method is provided for creating a historical tour plan and historical environment of a historical town and era. The method comprises the following steps. A user registers with a portal or a server of a tourist service provider by logging in a plurality of personal details of a user. A heritage tour program is selected from a plurality of tour programs offered by the tourist service provider for visiting a desired historical town and era. A plurality of participants from the logged in users is grouped for the selected heritage tour program. The details of the desired historical town and era of the selected heritage tour program are retrieved from plurality of data sources. A tour plan is generated for the plurality of participants based on the selected heritage tour program. A historical environment is created and presented to replicate a lifestyle, culture and environment of the desired historical town and era based on the retrieved details of the desired historical town and era of the selected heritage tour program.

62. According to one embodiment herein, the method further comprises the following additional steps. The dressings, clothes, costumes of people lived in the desired historical town and era, are collected. The collected dressings, clothes, costumes are supplied to the plurality of the participants of selected heritage tour program. The plurality of participants is trained to put on the supplied dressings, clothes, costumes. The plurality of participants is dressed up with a make-up of the people lived in the desired historical town and era. A plurality of sporting events and entertainments related to the desired historical town and era of the selected heritage tour program is generated and conducted. A plurality of tourist guides is selected and trained on a culture, lifestyle and living of the people of the desired historical town and era based on the based on the retrieved details of the desired historical town and era of the selected heritage tour program, to train and assist the plurality of participants in wearing the supplied dressings, clothes, costumes and in the dressing up process.

63. According to one embodiment herein, the plurality of personal details of a user comprises name, age, sex, hobbies, address and payment details.

64. According to one embodiment herein, the historic era is selected from the group consisting of a medieval period, The Roman and Greek empire, Iranian empire, crusades, and wild west.

65. According to one embodiment herein, the tour plan is generated and charted by a tour planning manager.

66. According to one embodiment herein, the plurality of data sources comprises a plurality of historians, the authors of historical books, the authentic historic books, the archaeological documents of historical eras, the directors and movie makers of historical era, a plurality of travel websites, social networking sites, and historical Wikipedia.

67. According to one embodiment herein, a system is provided for creating a historical tour plan and historical environment of a historical town and era. According to one embodiment herein, the system comprises a user device and a server in a portal of a tourist service provider for receiving a login details of a user from the user device and for supplying a plurality tour programs to the logged in user through the user device. A database is provided for storing a data of the plurality of tour programs, and an itinerary of each tour program. A logistic warehouse is provided for storing a plurality of articles of manufacture and a tour planning manager is connected to the server.

68. According to one embodiment herein, the plurality of tour programs supplied by the server comprise a plurality of heritage tour programs. The user selects a heritage tour program from the plurality of tour programs offered by the tourist service provider for visiting a desired historical town and era. The server groups a plurality of participants from the logged in users for the selected heritage tour program. The server further retrieves the details of the desired historical town and era of the selected heritage tour program from a plurality of data sources. The tour planning manager generates a tour plan for the plurality of participants based on the selected heritage tour program.

69. According to one embodiment herein, the server creates and presents a historical environment to the tour planning manager to replicate a lifestyle, culture and environment of the desired historical town and era based on the retrieved details of the desired historical town and era of the selected heritage tour program.

70. According to one embodiment herein, the server receives a plurality of personal details from the user during a login and registering process. The plurality of personal details of the user comprises name, age, sex, hobbies, address and payment details.

71. According to one embodiment herein, the tour planning manager collects the dressings, clothes, costumes of people lived in the desired historical town and era based on the details of the desired historical town and era of the selected heritage tour program retrieved by the server. The tour planning manager further supplies the collected dressings, clothes, costumes to the plurality of the participants of selected heritage tour program.

72. According to one embodiment herein, the tour planning manager generates and conducts a plurality of sporting events and entertainments related to the desired historical town and era of the selected heritage tour program based on the details of the desired historical town and era of the selected heritage tour program retrieved by the server.

73. According to one embodiment herein, the tour planning manager trains a plurality of tourist guides on a culture, lifestyle and living of the people of the desired historical town and era based on the retrieved details of the desired historical town and era of the selected heritage tour program, to train and assist training the plurality of participants to put on the supplied dressings, clothes, and costumes.

74. According to one embodiment herein, the plurality of tourist guides assists and helps the plurality of participants in dressing up with a make-up of the people lived in the desired historical town and era. The plurality of tourist guides assists and helps the plurality of participants in wearing the supplied dressings, clothes, costumes and in the dressing up process.

75. According to one embodiment herein, the historic era is selected from the group consisting of a medieval period, The Roman and Greek empire, Iranian empire, crusades, and Wild West.

76. According to one embodiment herein, the plurality of data sources comprises a plurality of historians, authors of historical books, authentic historic books, archaeological document of historical eras, directors and movie makers of historical era, plurality of travel websites, social networking sites, and historical Wikipedia.

77. According to one embodiment herein, the plurality of articles of manufacture comprises the dressings, clothes, costumes of people lived in the desired historical town and era collected by the tour planning manager.

78. According to one embodiment herein, the server provides a demo of a life style, living, dressing, culture, entertainment and sporting activities of the people of the desired historical town and era to the plurality of participants.

79. According to one embodiment herein, a computer implemented method is provided for creating a historical tour plan and historical environment of a historical town and era. The method comprises instructions that are stored on a storage medium and are run on a computing device to execute the following steps. A user registers with a portal or a server of a tourist service provider by logging in a plurality of personal details of a user, and the plurality of personal details of the user comprises name, age, sex, hobbies, address and payment details. A heritage tour program is selected from a plurality of tour programs offered by the tourist service provider for visiting a desired historical town and era, and the historical town and era is selected from the group consisting of a medieval period, Roman and Greek empire, Iranian empire, crusades, and wild west. A plurality of participants from the logged in users is grouped for the selected heritage tour program. The details of the desired historical town and era of the selected heritage tour program are retrieved from a plurality of data sources, and the plurality of data sources comprises a plurality of historians, authors of historical books, authentic historic books, archaeological document of historical eras, directors and movie makers of historical era, plurality of travel websites, social networking sites, and historical Wikipedia. A tour plan is generated for the plurality of participants based on the selected heritage tour program. A historical environment is created and presented to replicate a lifestyle, culture and environment of the desired historical town and era based on the retrieved details of the desired historical town and era of the selected heritage tour program.

80. According to one embodiment herein, the dressings, clothes, costumes of people lived in the desired historical town and era are collected.

81. According to one embodiment herein, the collected dressings, clothes, costumes are supplied to the plurality of the participants of selected heritage tour program.

82. According to one embodiment herein, the plurality of participants is trained to put on the supplied dressings, clothes, and costumes.

83. According to one embodiment herein, the plurality of participants is dressed up with a make-up of the people lived in the desired historical town and era.

84. According to one embodiment herein, a plurality of sporting events and entertainments related to the desired historical town and era of the selected heritage tour program are generated and conducted.

85. According to one embodiment herein, a plurality of tourist guides is selected and trained on a culture, lifestyle and living of the people of the desired historical town and era based on the based on the retrieved details of the desired historical town and era of the selected heritage tour program, to train and assist the plurality of participants in wearing the supplied dressings, clothes, costumes and in the dressing up process.

86. The various embodiments herein provide a method for creating a real time historical environment of a historical town for tourists based on the historical era preferred by a tourist. The method also provides a tour program that provides a historical era experience to the tourists according to their preference.

87. The method also creates a tour program that provides a historical era experience to the tourists according to their preference. The method collects necessary information and conditions pertaining to the tour program. The system further determines the various parameters related to the selected tour programs. The parameters include but not limited to the available facilities, limitations and timings for the tour program. The next step of the method is to set up the historical environment utilizing the available facilities. The method also provides a demo for presenting the tourist with a brief idea on the tour program. After watching the demo, the tourist registers for the tour program. The tourist is provided with an option to select any tour programs from the available tour packages. The tour program is accessible though website or dedicated mobile application. The tour program is also advertised by means of television, SMSs, emails and the like. The tourists register with the tour program by providing the details required for authentication. Once the tourist is registered with the tour program, a list of historical eras and schedule of the tour program is provided to the tourist. The tourist chooses a preferred historical environment from the list and confirms his enrollment with the tour program.

88. According to one embodiment herein, the tour program is initiated according to scheduled time. At the start of tour program, the tourists are grouped according to their preferred historical environment. Each of the tourist group is assigned with a tourist guide for providing assistance, information and cultural, historical and contemporary interpretation of the historical era. The tourist guides are trained according to the historical era they are representing. The tourist guides consult some historians, book authors, authentic books and documents for learning about the assigned historical eras. The tourist guides are regularly updated and informed about details of people's life in the past. The tourist guide provides explanation to the tourist group on the tour timetable, at the start of tour program.

89. According to one embodiment herein, before the commencement of the tour program, the tourists are provided with a set of clothes/dressings, costumes and make-up that suits the tour location and environment. In this case, all applicants and tour leaders look alike in appearance and they can feel themselves with the people of that historical time. After the commencement of the tour program, the tourists are welcomed in different ways. For example, the tourists are considered as ambassadors and guests according to the historical era and are welcomed traditionally by local people. The tour program proceeds further by initiating different entertainment programs.

90. According to one embodiment herein, the tour program facilitates the tourist to compare the communicative devices and transportation vehicles of the present time and the past time. The tour program provides the tourists with real time event experience of certain situations. For example, the tourists who wish to experience ancient Rome are gathered at the main square of the city standing on the ancient platforms. The tourists are further facilitated to watch real time programs which include plays, customs and fights that are specific and present in that historic time. The tour program also entertains the tourists by providing situations that create a sense of excitement, fear and other emotions among the tourists. For example, if the tourist wants to experience a Wild West or a cowboy's era, a real time situation is created so that a train accommodating the tourists is attacked by thieves that cause a sensation of fear among the tourists. The tour program also facilitate the tourists to visit historical places inhabiting native residents having their own customs The tour program facilitates the tourists to communicate with the native residents for acquiring information on lifestyle of past time.

91. According to one embodiment herein, the tour package is not restricted for creating the environments pertaining to the historical era. The tour package also provides other real time experiences for tourists. For example, the tourists are provided with an opportunity to play a role like a movie star in a movie.

92. The various embodiments herein provide a method and system for creating and conducting a heritage tour plan of a historical town and era. According to one embodiment, a method is provided for a heritage tour plan of a historical town and era. The method comprises receiving a plurality of profile characteristics from one or more participants; receiving the details of historic eras comprising culture, customs and religion of the time, which they want to experience, from one or more participants; retrieving details of historic eras comprising culture, customs and religion of the time from plurality of data sources comprising plurality of travel websites, social networking sites, historical Wikipedia; automatically computing a tour plan for the participants based on selected historic eras; and directing the participants on how to put on their costumes chosen beforehand and also their makeup by a makeup artist.

93. According to one embodiment herein, the plurality of profile characteristics comprises name, age, sex, hobbies, address and payment details.

94. According to one embodiment herein, the historic era is any of the era selected for the group comprising medieval, The Roman and Greek empire, Iranian empire, crusades, and wild west.

95. According to one embodiment herein, the tour plan is computed by a tour planning manager.

96. According to one embodiment herein, the participants are directed on how to put on their costumes by a one or more tour leaders, and wherein the team leaders are trained according to the historical era they are representing, and wherein the tour leaders consults one or more historians, authors, authentic books, documents, directors and movie makers for gathering information about details of people's life in the past.

97. According to one embodiment herein, a system is provided for a heritage tour plan of a historical town and era. The system comprises a logistic warehouse comprising plurality of logistics; a database hosting a plurality of travel objects, each having a plurality of scheduling characteristics; a website comprising an input interface for receiving a plurality of profile characteristics and participant interested historical era from one or more participants via a network; and a tour planning manager for automatically computing a tour plan for the participants.

98. According to one embodiment herein, the tour planning manager computes an arrangement of members of said group in a schedule according to said plurality of profile characteristics. The tour planning manager computes an arrangement of one or more trained tour leaders for one or more participants based on the participants selected tour plan. The tour planning manager receives one or more participants profile characteristics, participants selected historical era, available facilities, limitations and timetables of the tour programs for the particular historical era selected by the participants and computes the tour plan for the one or more participants.

99. According to one embodiment herein, the tour plan relates to specific historical era and the entire tour plan is briefed to the participants by the tour plan manager.

100. According to one embodiment herein, the plurality of logistics comprises costumes such as clothing, appeals, makeup items, etc for matching with the culture, customs and religion of the time of the specific historic era.

101. According to one embodiment herein, the historic era is any of the era selected for the group comprising medieval, The Roman and Greek empire, Iranian empire, crusades, and wild west.

102. According to one embodiment herein, the tour program is accessible through a website, and wherein the participants accesses to their favourite historical era and register through the website.

103. According to one embodiment herein, the website checks for available facilities, limitations and timetables of the tour programs for the particular historical era selected by the participants. The website provides a demo for the participant selected historical era, and wherein the website allows the participants to confirm the selected historical era, change the historical era or choose for different costumes for attending the tour. The website allows the participants to choose between their favourite historical eras by referring to the plurality of travel websites, social networking sites, historical Wikipedia, etc.

104. According to one embodiment herein, the system generates an entertainment attraction. The entertainment attraction comprises a plethora of activities and exhibits entertainment and excitement in the context of entertainment arising from haunted movie themes. The entertainment attraction is developed using actual movie artifacts, film props, costumes and historic publicity materials from original movies.

105. FIG. 1 illustrates a flowchart explaining a method for creating a real time environment depending on the historical era preferred by the tourist, according to one embodiment herein. With respect to FIG. 1, the method collects the necessary information and conditions pertaining to the tour program (101). The method further determines the various parameters such as available facilities, limitations and timings for the tour program. The next step of the method is to set up the historical environment utilizing the available facilities (102). The method also provides a demo for presenting the tourist with a brief idea on the tour. After watching the demo, the tourist registers for the tour program (103). The tourist is provided with an option to select any tour programs from the available tour packages.

106. The tour program is accessible though website or dedicated mobile application. The tour program is also advertised by means of television, short message service (SMS), e-mails and the like. The tourists register with the tour program by providing the details required for authentication. Once the tourist is registered with the tour program, a list of historical eras and schedule of the tour program is provided to the tourist. The tourist chooses preferred historical environment from the list and confirms his enrollment with the tour program.

107. According to one embodiment herein, the tour program is initiated according to scheduled time. At the start of tour program, the tourists are grouped according to their preferred historical environment. Each of the tourist group is assigned with a guide for providing assistance, information and cultural, historical and contemporary interpretation of the historical era. The tourist guides are trained according to the historical era they are representing (104). The tourist guides consult some historians, historical book authors, authentic historical books and documents for learning about the assigned or selected or preferred historical eras. The tourist guides are regularly updated and informed about details of the life style, culture, habits, dressings, costumes, food habits, sports activities of the people of the preferred historical era and town/city. The tourist guide provides an explanation to the tourist group on the tour timetable, at the start of tour program.

108. According to one embodiment herein, before the commencement of the tour program, the tourists are presented with a set of clothes and makeup that suits the tour location and environment. In this case, all applicants and tour leaders look alike in appearance and they can feel themselves and identify themselves with the people of that historical time. After the commencement of the tour program, the tourists are welcomed in different ways, for example, the tourists are considered as ambassadors and guests according to the historical era and are welcomed traditionally by local people. The tour program proceeds further by initiating different entertainment programs.

109. According to one embodiment herein, the tour program facilitates the tourist to compare the communicative devices and transportation vehicles of the present time and the past time. The tour program provides the tourists with real time event experience of certain situations (105). For example, the tourists who wish to experience ancient Rome are gathered at the main square of the city standing on the ancient platforms. The tourists are further facilitated to watch real time programs which include plays, customs and fights specific to the preferred historic time. The tour program also entertains the tourists by providing the situations that create a sense of excitement, fear and other emotions among the tourists. For example, if the tourist wants to experience a Wild West or a cowboy's era, a real time situation is created to replicate a train accommodating the tourists being attacked by thieves to provide a sensation of fear among the tourists. The tour program also facilitate the tourists to visit historical places inhabiting native residents having their own customs The tour program facilitates the tourists to communicate with the native residents for acquiring information on lifestyle of past time.

110. According to one embodiment herein, the tour package is not restricted for creating environments pertaining to historical era. The tour package also provides other real time experiences such as, for example, tourists are provided with an opportunity to play a role like a movie star in a movie.

111. FIG. 2 illustrates a block diagram of a system or a portal for creating a cultural and heritage tour program for visiting a historical town/city and creating a historical environment for the tourists, according to one embodiment herein.

112. With respect to FIG. 2, a system is provided for creating a historical tour plan and historical environment of a historical town and era. The system comprises a user device 201 and a server 202 residing in a portal of a tourist service provider for receiving a login details of a user from the user device 201 and for supplying a plurality tour programs to the logged in user through the user device 201. A database 203 is provided for storing a data of the plurality of tour programs, and an itinerary of each tour program. A logistic warehouse 204 is provided for storing a plurality of articles of manufacture and a tour planning manager is connected to the server.

113. The plurality of tour programs supplied by the server 202 comprises a plurality of heritage tour programs. The user selects a heritage tour program from the plurality of tour programs offered by the tourist service provider for visiting a desired historical town and era. The server 202 groups a plurality of participants from the logged in users for the selected heritage tour program. The server 202 further retrieves the details of the desired historical town and era of the selected heritage tour program from a plurality of data sources. The tour planning manager 205 generates a tour plan for the plurality of participants based on the selected heritage tour program.

114. The server 202 creates and presents a historical environment to the tourist service provider system 205 to replicate a lifestyle, culture and environment of the desired historical town and era based on the retrieved details of the desired historical town and era of the selected heritage tour program. The tourist service provider system 205 comprises a tour plan manger device 206 provided with a tour plan management module and a training system 207 provided with a simulation engine and a training module.

115. The server 202 receives a plurality of personal details from the user during a login and registering process. The plurality of personal details of the user comprises name, age, sex, hobbies, address and payment details.

116. The tour plan manager device 206 collects the dressings, clothes, costumes of people lived in the desired historical town and era based on the details of the desired historical town and era of the selected heritage tour program retrieved by the server 202. The tour plan manager device 206 stores the collected dressings, clothes, costumes of people lived in the desired historical town and era on the logistic warehouse 204. The tour plan manager device 206 further supplies the collected dressings, clothes, costumes to the plurality of the participants of selected heritage tour program.

117. The tour plan manager device 206 generates and conducts a plurality of sporting events and entertainments related to the desired historical town and era of the selected heritage tour program based on the details of the desired historical town and era of the selected heritage tour program retrieved by the server 202.

118. The tour plan manager device 206 selects and trains a plurality of tourist guides on a culture, lifestyle and living of the people of the desired historical town and era based on the retrieved details of the desired historical town and era of the selected heritage tour program, to train and assist training the plurality of participants to put on the supplied dressings, clothes, and costumes.

119. The plurality of tourist guides assists and helps the plurality of participants in dressing up with a make-up of the people lived in the desired historical town and era. The plurality of tourist guides assists and helps the plurality of participants in wearing the supplied dressings, clothes, costumes and in the dressing up process.

120. According to one embodiment herein, the historic era is selected from the group consisting of a medieval period, The Roman and Greek empire, Iranian empire, crusades, and Wild West.

121. According to one embodiment herein, the plurality of data sources comprises a plurality of historians, authors of historical books, authentic historic books, archaeological document of historical eras, directors and movie makers of historical era, plurality of travel websites, social networking sites, and historical Wikipedia.

122. According to one embodiment herein, the plurality of articles of manufacture comprises the dressings, clothes, costumes of people lived in the desired historical town and era collected by the tour planning manager.

123. The server 202 provides a demo of a life style, living, dressing, culture, entertainment and sporting activities of the people of the desired historical town and era to the plurality of participants.

124. According to an embodiment herein, a computing system comprising a hardware processor and a memory is provided for creating a historical tour plan and historical environment of a historical town and era. The system comprises a user device 201 provided with a hardware processor and memory. A server device 202 is configured for receiving a login details of a user from the user device 201 and for supplying a plurality tour programs to the logged in user through the user device 201. The plurality tour programs comprises a plurality of heritage tour programs.

125. A tour plan manager device 206 is configured to generate a tour plan for the plurality of participants based on the selected heritage tour program through a tour plan management module. The tour plan manager device is further configured to collect details of dressings, clothes, costumes of people who lived in the desired historical town and era with the tour plan management module. The tour plan manager device 206 is further configured to purchase dressings, clothes and costumes of people who lived in the desired historical town and era through e-commerce or online purchase. The purchased dressings, clothes and costumes of people who lived in the desired historical town and era are stored in a logistics warehouse 204. The tour plan manager device 206 is configured to supply the purchased dressings, clothes, costumes to the plurality of the participants of selected heritage tour program. A simulation engine is run on a training system 207 to simulate an environment of the desired historical town and era through a simulation engine for training the plurality of participants to put on the supplied dressings, clothes, costumes. A training module is run on the training system 207 and configured to provide instructions to the plurality of participants for dressing up the plurality of participants with a make-up of the people who lived in the desired historical town and era. The training module is run on the training system 207 and configured for providing instructions to the plurality of participants for generating and conducting a plurality of sporting events and entertainments related to the desired historical town and era of the selected heritage tour program. The training module is run on the training system 207 and configured for providing instructions for training a plurality of tourist guides on a culture, lifestyle and living of the people of the desired historical town and era based on the retrieved details of the desired historical town and era of the selected heritage tour program, to train and assist the plurality of participants in wearing the supplied dressings, clothes, costumes and in the dressing up process. A database 203 is configured for storing a data of the plurality of tour programs, and an itinerary of each tour program. The user device 201 is configured to select a heritage tour program from the plurality of tour programs offered by the tourist service provider for visiting a desired historical town and era. The server device 202 is configured to group a plurality of participants from the logged in users for the selected heritage tour program. The server device 202 is configured to retrieves details of the desired historical town and era of the selected heritage tour program from a plurality of data sources. The historic era is selected from the group consisting of a medieval period, Roman and Greek empire, Iranian empire, crusades, and wild west. The plurality of data sources comprises a plurality of historians, authors of historical books, authentic historic books archaeological document of historical eras, directors and movie makers of historical era, plurality of travel websites, social networking sites, and historical Wikipedia.

126. According to an embodiment herein, the server device 202 is configured to create and present a historical environment to the tour plan manager device to replicate a lifestyle culture and environment of the desired historical town and era based on the retrieved details of the desired historical town and era of the selected heritage tour program.

127. According to an embodiment herein, the server device 202 is configured to receive a plurality of personal details from the user during a login and registering process, and wherein the plurality of personal details of the user comprises name, age, sex, hobbies, address and payment details.

128. According to an embodiment herein, the tour plan manager device 206 is configured to provide instructions for generating and conducting a plurality of sporting events and entertainments related to the desired historical town and era of the selected heritage tour program based on the details of the desired historical town and era of the selected heritage tour program retrieved by the server device.

129. According to an embodiment herein, the tour plan manager device 206 is configured to provide instructions to train a plurality of tourist guides on a culture, lifestyle and living of the people of the desired historical town and era based on the based on the retrieved details of the desired historical town and era of the selected heritage tour program, to train and assist training the plurality of participant to put on the supplied dressings, clothes and costumes.

130. According to an embodiment herein, the server device 202 is configured to provide a demo of a life style, living, dressing, culture, entertainment and sporting activities of the people of the desired historical town and era to the plurality of participants.

131. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

132. Although the embodiments herein are described with various specific embodiments, it will be obvious for a person skilled in the art to practice the invention with modifications. However, all such modifications are deemed to be within the scope of the claims.

133. It is also to be understood that the following claims are intended to cover all of the generic and specific features of the embodiments described herein and all the statements of the scope of the embodiments which as a matter of language might be said to fall there between.

What is claimed is:

1. A computer implemented method comprising instructions stored on a non-transitory computer readable storage medium and run on a hardware processor in a computing device for creating a historical tour plan and historical environment of a historical town and era, the method comprises the steps of:
registering of a user with a portal or a server device of a tourist service provider by logging in a plurality of personal details of the user through a user device, and wherein the plurality of personal details of the user comprises name, age, sex, hobbies, address and payment details;
selecting a heritage tour program from a plurality of tour programs offered by a tourist service provider system for visiting a desired historical town and era through the user device, and wherein the historic era is selected from a group consisting of a medieval period, Roman and Greek empire, Iranian empire, crusades, and wild west;
grouping a plurality of participants from the logged in users for the selected heritage tour program by the server device;
retrieving details of the desired historical town and era of the selected heritage tour program from a plurality of data sources by the server device, wherein the plurality of data sources comprises a plurality of historians, authors of historical books authentic historic books archaeological documents of historical eras, directors and movie makers of historical era, a plurality of travel websites, social networking sites, and historical Wikipedia;
generating a tour plan for the plurality of participants based on the selected heritage tour program by a tour plan manager device through a tour plan management module; and
creating and presenting a historical environment using a simulation engine to replicate a lifestyle, culture and environment of the desired historical town and era based on the retrieved details of the desired historical town and era of the selected heritage tour to enable a tour operator to recreate a historical era for visit for the registered users.

2. The method according to claim 1 further comprises:
collecting details of dressings, clothes, costumes of people who lived in the desired historical town and era by the tour planning module;
purchasing dressings, clothes and costumes of people who lived in the desired historical town and era through e-commerce or online purchase by the tour planning module;
storing the purchased dressings, clothes and costumes of people who lived in the desired historical town and era in a logistics warehouse;
supplying the collected dressings, clothes, costumes to the plurality of the participants of selected heritage tour program through the tour planning device;
simulating an environment of the desired historical town and era through the simulation engine in a training device for training the plurality of participants to put on the supplied dressings, clothes, costumes through a training module;
providing instructions to the plurality of participants for dressing up the plurality of participants with a make-up of the people who lived in the desired historical town and era through the training module;
providing instructions to the plurality of participants for generating and conducting a plurality of sporting events and entertainments related to the desired historical town and era of the selected heritage tour program through the training module; and
training a plurality of tourist guides on a culture, lifestyle and living of the people of the desired historical town and era by providing instructions through the training module based on the retrieved details of the desired historical town and era of the selected heritage tour program, to train and assist the plurality of participants in wearing the supplied dressings, clothes, costumes and in the dressing up process.

3. The method according to claim 1, wherein the tour planning manager module is run on a hardware processor and configured to generate and chart the tour plan.

4. A computing system comprising a hardware processor and a memory for creating a historical tour plan and historical environment of a historical town and era, the system comprises:
a user device;
a server device configured for receiving a login details of a user from the user device and for supplying a plurality tour programs to the logged in user through the user device, and wherein the plurality tour programs comprises a plurality of heritage tour programs;
a tour plan manager device configured to generate a tour plan for the plurality of participants based on the selected heritage tour program through a tour plan management module, and wherein the tour plan manager device is further configured to collect details of dressings, clothes, costumes of people who lived in the desired historical town and era with the tour plan management module, and wherein the tour plan manager device is further configured to purchase dressings, clothes and costumes of people who lived in the desired historical town and era through e-commerce or online purchase, and wherein the purchased dressings, clothes and costumes of people who lived in the desired historical town and era are stored in a logistics warehouse and wherein the tour plan manager device is configured to supply the purchased dressings, clothes, costumes to the plurality of the participants of selected heritage tour program;
a simulation engine run on a training system to simulate an environment of the desired historical town and era through a simulation engine for training the plurality of participants to put on the supplied dressings, clothes, costumes,
a training module run on the training system and configured to provide instructions to the plurality of participants for dressing up the plurality of participants with a make-up of the people who lived in the desired historical town and era, and wherein the training module is run on the training system and configured for providing instructions to the plurality of participants for generating and conducting a plurality of sporting events and entertainments related to the desired historical town and era of the selected heritage tour program, and wherein the training module is run on the training system and configured for providing instructions for training a plurality of tourist guides on a culture, lifestyle and living of the people of the desired historical town and era based on the retrieved details of the desired historical town and era of the selected heritage tour program, to train and assist the plurality of participants in wearing the supplied dressings, clothes, costumes and in the dressing up process;
a database configured for storing a data of the plurality of tour programs, and an itinerary of each tour program; and
wherein the user device is configured to select a heritage tour program from the plurality of tour programs offered by the tourist service provider for visiting a desired historical town and era, and wherein the server device is configured to group a plurality of participants from the logged in users for the selected heritage tour program and wherein the server device is configured to retrieves details of the desired historical town and era of the selected heritage tour program from a plurality of data sources, and, wherein the historic era is selected from the group consisting of a medieval period, Roman and Greek empire, Iranian empire, crusades, and wild west, wherein the plurality of data sources comprises a plurality of historians, authors of historical books, authentic historic books archaeological document of historical eras, directors and movie makers of historical era, plurality of travel websites, social networking sites, and historical Wikipedia.

5. The system according to claim 4, wherein the server device is configured to create and present a historical environment to the tour planning manager module to replicate a lifestyle culture and environment of the desired historical town and era based on the retrieved details of the desired historical town and era of the selected heritage tour program.

6. The system according to claim 4, wherein the server device is configured to receive a plurality of personal details from the user during a login and registering process, and wherein the plurality of personal details of the user comprises name, age, sex, hobbies, address and payment details.

7. The system according to claim 4, wherein the tour plan manager device is configured to provide instructions for generating and conducting a plurality of sporting events and entertainments related to the desired historical town and era of the selected heritage tour program based on the details of the desired historical town and era of the selected heritage tour program retrieved by the server device.

8. The system according to claim 4, wherein the tour plan manager device is configured to provide instructions to train a plurality of tourist guides on a culture, lifestyle and living of the people of the desired historical town and era based on the based on the retrieved details of the desired historical town and era of the selected heritage tour program, to train and assist training the plurality of participant to put on the supplied dressings, clothes and costumes.

9. The system according to claim 4, wherein the server device is configured to provide a demo of a life style, living, dressing, culture, entertainment and sporting activities of the people of the desired historical town and era to the plurality of participants.
